(19) United States
(12) Patent Application Publication
(10) Pub. No.: US 2011/0057605 A1
(43) Pub. Date: Mar. 10, 2011

(54) Power Supply System with Power Saving Function and Power Supply Method Thereof

(75) Inventors: Jung-Hua Chung, Taipei (TW); Yung-Lu Wu, Taipei (TW); Wen-Chun Shen, Taipei (TW)

(73) Assignee: PEGATRON CORPORATION, Taipei (TW)

(21) Appl. No.: 12/853,370

(22) Filed: Aug. 10, 2010

(30) Foreign Application Priority Data
Sep. 8, 2009 (TW) 098130175

(51) Int. Cl. H02J 7/00

(52) U.S. Cl. 320/107

(57) ABSTRACT

This invention discloses a power supply system and power supply method with a power saving function for a rechargeable battery. The power supply system includes a power adapter and a portable electronic device body. The power adapter has a control pin. The portable electronic device body includes a connector, a charging unit, and an embedded controller. The embedded controller is used for detecting a capacity state of the rechargeable battery and whether the rechargeable battery is connected with the connector to determine whether the rechargeable battery needs to be charged. When the rechargeable battery does not need to be charged, the embedded controller controls the power adapter to output a first voltage via the control pin. When the rechargeable battery needs to be charged, the embedded controller controls the power adapter to output a second voltage via the control pin. The first voltage is lower than the second voltage.

### CROSS-REFERENCE TO RELATED APPLICATIONS

This Non-provisional application claims priority under 35 U.S.C. §119(a) on Patent Application No(s). 098130175 filed in Taiwan, Republic of China on Sep. 8, 2009, the entire contents of which are hereby incorporated by reference.

### BACKGROUND OF THE INVENTION

1. Field of the Invention

This invention relates to a power supply system and, more particularly, to a power supply system with a power saving function and a power supply method thereof.

2. Description of the Related Art

At present, a portable electronic device (such as a notebook computer, a portable personal computer, and a handheld computer and so on) usually equips with a power adapter. A notebook computer is taken for example. The power adapter can be connected with commercial power for supplying power for the computer system and charging a battery of the notebook computer.

Usually, the higher a voltage of the power adapter outputs, the lower the system efficiency is. To satisfy charging needs, the conventional power adapter outputs a high fixed voltage (such as 19V). When the battery is fully charged, the power adapter may always output the high voltage, thereby reducing conversion efficiency of the system.

### BRIEF SUMMARY OF THE INVENTION

This invention provides a power supply system with a power saving function and a power supply method thereof to improve the prior art.

This invention provides a power supply system with a power saving function for a rechargeable battery. The power supply system includes a power adapter and a portable electronic device body. The power adapter has a control pin. The portable electronic device body includes a connector, a charging unit, and an embedded controller. The connector is used for connecting the rechargeable battery. The charging unit is coupled with the connector and the power adapter. The embedded controller is coupled with the control pin, the connector, and the charging unit. The embedded controller is used for detecting a capacity state of the rechargeable battery and whether the rechargeable battery is connected with the connector to determine whether the rechargeable battery needs to be charged. When the rechargeable battery does not need to be charged, the embedded controller controls the power adapter to output a first voltage to the portable electronic device body via the control pin. When the rechargeable battery needs to be charged, the embedded controller controls the power adapter to output a second voltage to the portable electronic device body via the control pin and controls the charging unit to use the second voltage to charge the rechargeable battery. The first voltage is lower than the second voltage.

This invention also provides a power supply method with a power saving function for a rechargeable battery. The power supply method includes the following steps. An embedded controller is used to detect a capacity state of the rechargeable battery and whether the rechargeable battery is connected with the connector to determine whether the rechargeable battery needs to be charged. When the rechargeable battery does not need to be charged, the embedded controller controls the power adapter to output a first voltage via the control pin. When the rechargeable battery needs to be charged, the embedded controller controls the power adapter to output a second voltage via the control pin and controls the charging unit to use the second voltage to charge the rechargeable battery. The first voltage is lower than the second voltage.

According to the power supply system in the invention, the power adapter additionally has a control pin and the embedded controller is used to detect the capacity state of the rechargeable battery and whether the rechargeable battery is connected with the connector to determine whether the rechargeable battery needs to be charged. In addition, according to different states of the rechargeable battery, the power supply system outputs different voltages to the computer system. When the rechargeable battery needs to be charged, the high voltage is outputted. When the rechargeable battery does not need to be charged (the battery is not connected or is fully charged), the lower voltage is outputted. Thereby, the energy conversion efficiency of the power system of the portable electronic device can be improved, and the structure is simple and is easy to be realized.

These and other features, aspects, and advantages of the present invention will become better understood with regard to the following description, appended claims, and accompanying drawings.

### BRIEF DESCRIPTION OF THE DRAWINGS

FIG. 1 is a functional block diagram showing a power supply system according to one preferred embodiment of the invention.

FIG. 2 is a flowchart showing a power supply method according to one preferred embodiment of the invention.

FIG. 3 is a functional block diagram showing a power supply system according to another preferred embodiment of the invention.

FIG. 4 is a flowchart showing a power supply method according to another preferred embodiment of the invention.

### DETAILED DESCRIPTION OF THE INVENTION

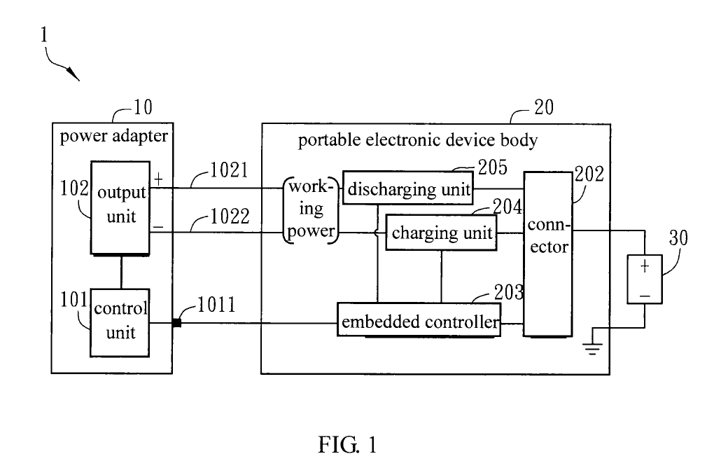

FIG. 1 is a functional block diagram showing a power supply system according to one preferred embodiment of the invention. In the embodiment, a power supply system 1 is for a rechargeable battery 30. For example, the power supply system 1 can control the rechargeable battery 30 to be charged or discharged.

In the embodiment, the rechargeable battery 30 may be a lithium battery. However, the invention is not limited thereto. In other embodiments, the rechargeable battery 30 may be a nickel-cadmium battery or a nickel-metal hydride battery.

In the embodiment, the rechargeable battery 30 includes six pins for connecting the power supply system 1. A first pin is a positive electrode, a second pin is a pin for detecting whether the battery is connected, a third pin is a data pin for transmitting battery parameters, a fourth pin is an empty pin, and a fifth pin is a ground pin.

In the embodiment, the rechargeable battery 30 can include a battery management chip (such as a Gauge IC). The battery management chip includes a series of registers for storing parameters such as battery capacity, temperature, battery identification codes, battery states, charging states, discharging times and so on. The parameters gradually changes in a using process of the rechargeable battery 30. In the embodiment, the parameters of the rechargeable battery 30 can be transmitted to the power supply system 1 via the data pin to perform corresponding charging or discharging operation.

In the embodiment, the power supply system 1 includes a power adapter 10 and a portable electronic device body 20. The portable electronic device body 20 can use working power provided by the power adapter 10 or the rechargeable battery 30 to perform different operation.

In the embodiment, the portable electronic device body 20 may be a notebook computer body. However, the invention is not limited thereto. In other embodiments, the portable electronic device body 20 may be a mobile phone body.

In the embodiment, the portable electronic device body 20 includes a connector 202, an embedded controller 203, a charging unit 204, and a discharging unit 205. The connector 202 is used for connecting the rechargeable battery 30 and can receive the parameters of the rechargeable battery 30. The embedded controller 203 is coupled with the connector 202, the charging unit 204, and the discharging unit 205. The charging unit 204 and the discharging unit 205 are also coupled with the connector 202.

In the embodiment, in a charging state, the charging unit 204 converts the working power (such as the working power from the power adapter 10) to charging power of the rechargeable battery 30 thus to charge the rechargeable battery 30.

In the embodiment, in a discharging state, the discharging unit 205 can convert output power of the rechargeable battery 30 to the power needed by operation of different functional units in the portable electronic device body 20.

In the embodiment, the embedded controller 203 can detect a state of the connector 202. For example, the embedded controller 203 can determine whether the rechargeable battery 30 is connected by detecting whether the connector 202 is connected with the second pin of the rechargeable battery 30. In addition, the embedded controller 203 can detect whether the power adapter 10 is connected with the portable electronic device body 20.

In the embodiment, the embedded controller 203 can receive the state parameters of the rechargeable battery 30 from the connector 202, and the state parameters may include whether the rechargeable battery 30 needs to be charged at present and the present capacity.

In the embodiment, when the rechargeable battery 30 does not need to be charged, the embedded controller 203 can output a first state control signal. In detail, there are two conditions that the rechargeable battery 30 does not need to be charged. The first condition is that the embedded controller 203 detects that the rechargeable battery 30 is not connected with the connector 202. The second condition is that the state parameter of the rechargeable battery 30 received by the embedded controller 203 indicates that the rechargeable battery 30 does not need to be charged at that moment. In this condition, usually the capacity of the rechargeable battery 30 is greater than a predetermined value. For example, the capacity may be greater than 95% of full capacity of the rechargeable battery 30. The predetermined value can be set when the rechargeable battery 30 leaves the factory according to needs, and it can also be set by users via software. However, the invention is not limited thereto.

In the embodiment, the first state control signal may be a low level control signal. In other embodiments, it may also be a high level control signal. However, the invention is not limited thereto.

In another aspect, in the embodiment, when the state parameter of the rechargeable battery 30 received by the embedded controller 203 indicates that the rechargeable battery 30 needs to be charged, the embedded controller 203 can output a second state control signal. At that moment, the capacity of the rechargeable battery 30 is usually lower than the predetermined value. However, the invention is not limited thereto.

In the embodiment, whether the rechargeable battery 30 needs to be charged is determined according to whether the rechargeable battery 30 is connected with the connector 202 and whether the capacity of the rechargeable battery 30 is greater than a predetermined value. That is, in this embodiment, the determination whether the rechargeable battery 30 needs to be charged does not depend on whether the portable electronic device body 20 is started up.

In the embodiment, the embedded controller 203 determines whether the rechargeable battery 30 needs to be charged, and the operation of the embedded controller 203 does not depend on start-up of the portable electronic device body 20. Therefore, even if the portable electronic device body 20 is in a shutdown state, once the embedded controller 203 determines that the rechargeable battery 30 needs to be charged, the embedded controller 203 can still output the second state control signal.

In the embodiment, the second state control signal may correspondingly be a high level control signal. In other embodiments, it may correspondingly be a low level control signal. However, the invention is not limited thereto.

In the embodiment, when the embedded controller 203 detects that the power adapter 10 is connected with the portable electronic device body 20, and the rechargeable battery 30 needs to be charged, the embedded controller 203 can control the charging unit 204 to charge the rechargeable battery 30 until the rechargeable battery 30 is fully charged.

When the embedded controller 203 detects that the power adapter 10 is not connected with the portable electronic device body 20, the embedded controller 203 can control the discharging unit 205 to discharge the rechargeable battery 30.

In the embodiment, the power adapter 10 has a control pin 1011 coupled with the embedded controller 203. The power adapter 10 includes a control unit 101 and an output unit 102. The control unit 101 is coupled with the output unit 102 and the control pin 1011, respectively.

In the embodiment, the control pin 1011 receives the first state or second state control signal outputted from the embedded controller 203 and transmits the control signal to the control unit 101. The control unit 101 controls the output unit 102 to output a corresponding voltage to the portable electronic device body 20 according to the control signal.

In the embodiment, when the rechargeable battery 30 does not need to be charged, the embedded controller 203 outputs the first state control signal, the control pin 1011 outputs the received first state control signal to the control unit 101. The control unit 101 can output a first voltage, such as a voltage of 12V, to the portable electronic device body 20 according to the first state control signal.

When the rechargeable battery 30 needs to be charged, the embedded controller 203 outputs the second state control signal, the control pin 1011 outputs the received second state control signal to the control unit 101. The control unit 101 can output a second voltage, such as a voltage of 19V, to the portable electronic device body 20 according to the second state control signal. When the portable electronic device body 20 normally operates, the embedded controller 203 can further control the charging unit 204 to use the second voltage to charge the rechargeable battery 30. In the embodiment, the first voltage is lower than the second voltage.

In the embodiment, when the rechargeable battery 30 needs to be charged and the portable electronic device body 20 is in the shutdown state, the control unit 101 can still output the second voltage, such as a voltage of 19V, to the portable electronic device body 20 according to the second state control signal outputted from the embedded controller 203. Thereby, the embedded controller 203 can still control the charging unit 204 to use the second voltage to charge the rechargeable battery 30. That is, in the embodiment, no matter whether the portable electronic device body 20 is started up, the charge for the rechargeable battery 30 is performed by the charging unit 204.

Usually, a battery needs a higher voltage during charge to allow current to flow into the battery. Meanwhile, the current also needs to be accurately controlled within a predetermined value to ensure safety of the battery. Therefore, in a charging process, the charging voltage needs to increase with the increase of the voltage of the battery thus to prevent too much current from wholly entering into the battery in a short time to cause execution of an over-current protection function of the battery or explosion of the battery due to over-heat.

Compared with the power adapter 10, the charging unit 204 usually has a current limit function, while the power adapter 10 usually only has an over-current protection function (greater than charging current). Therefore, in the shutdown state, in the embodiment, the charging unit 204 still can be used to charge the rechargeable battery 30 to prevent the power adapter 10 from directly charging the rechargeable battery 30 thus to protect the rechargeable battery 30.

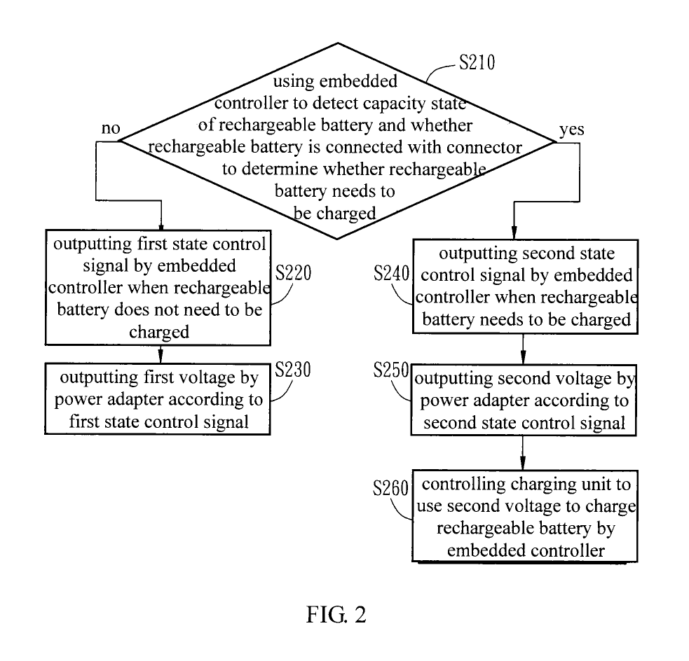

FIG. 2 is a flowchart showing a power supply method according to one preferred embodiment of the invention. Please refer to FIG. 1 and FIG. 2 together.

In step S210, an embedded controller 203 is used to detect a capacity state of the rechargeable battery 30 and whether the rechargeable battery 30 is connected with a connector thus to determine whether the rechargeable battery needs to be charged.

In detail, the embedded controller 203 determines whether the rechargeable battery 30 is connected by detecting whether the connector 202 is connected with the second pin of the rechargeable battery 30. In addition, the embedded controller 203 can further detect whether the power adapter 10 is connected with the portable electronic device body 20. The embedded controller 203 can receive the state parameter of the rechargeable battery 30 in the battery management chip via the third pin connected with the connector 202, and the state parameter may include whether the rechargeable battery 30 needs to be charged at present and the present battery capacity.

In step S220, when the rechargeable battery 30 does not need to be charged, the embedded controller 203 outputs a first state control signal.

In detail, there are two conditions that the rechargeable battery 30 does no need to be charged. The first condition is that the embedded controller 203 detects that the rechargeable battery 30 is not connected with the connector 202. The second condition is that the state parameter of the rechargeable battery 30 received by the embedded controller 203 indicates that the rechargeable battery 30 does not need to be charged. In the condition, usually the capacity of the rechargeable battery 30 is greater than a predetermined value. For example, the capacity may be greater than 95% of full capacity of the rechargeable battery 30. However, the invention is not limited thereto.

In the embodiment, the first state control signal can be a low level control signal. In other embodiments, the first state control signal may also be a high level control signal. However, the invention is not limited thereto.

In step S230, the power adapter 10 outputs a first voltage according to the first state control signal.

In detail, the control pin 1011 of the power adapter 10 receives the first state control signal and transmits the first state control signal to the control unit 101. The control unit 101 controls the output unit 102 to output the first voltage according to the first state control signal and supplies power for the portable electronic device body 20 via an output positive electrode 1021 and an output negative electrode 1022. The first voltage can be 12V, and it can be used as a working voltage of the portable electronic device body 20 to maintain normal operation. However, the invention is not limited thereto.

In step S240, when the rechargeable battery 30 needs to be charged, the embedded controller 203 outputs the second state control signal.

In detail, when the state parameter of the rechargeable battery 30 received by the embedded controller 203 indicates that the rechargeable battery 30 needs to be charged, the embedded controller 203 can output the second state control signal. At that moment, the capacity of the rechargeable battery 30 is usually lower than the predetermined value. However, the invention is not limited thereto.

In the embodiment, the second state control signal can correspondingly be a high level control signal. In other embodiments, the second state control signal may correspondingly be a low level control signal. However, the invention is not limited thereto.

In step S250, the power adapter 10 outputs a second voltage according to the second state control signal.

In detail, the power adapter 10 receives the second state control signal via the control pin 1011 and transmits the second state control signal to the control unit 101. The control unit 101 controls the output unit 102 to output the second voltage to the portable electronic device body 20 via the output positive electrode 1021 and the output negative electrode 1022 according to the second state control signal. In the embodiment, the second voltage can be 19V. However, the invention is not limited thereto.

In step S260, the embedded controller 203 controls the charging unit 204 to use the second voltage to charge the rechargeable battery 30.

In the embodiment, in one aspect, the second voltage is used as a working voltage of the portable electronic device body 20 to maintain the normal operation. In another aspect, the charging unit 204 is controlled by the embedded controller 203 to convert the second voltage to the charging voltage of the rechargeable battery 30 to charge the rechargeable battery 30.

In the above method, the power adapter 10 is connected with the portable electronic device body 20. In addition, when the embedded controller 203 detects that the power adapter 10 is not connected with the portable electronic device body 20, the embedded controller 203 controls the discharging unit 205 to supply power for the rechargeable battery 30 to provide the working voltage for the portable electronic device body 20 to maintain the normal operation.

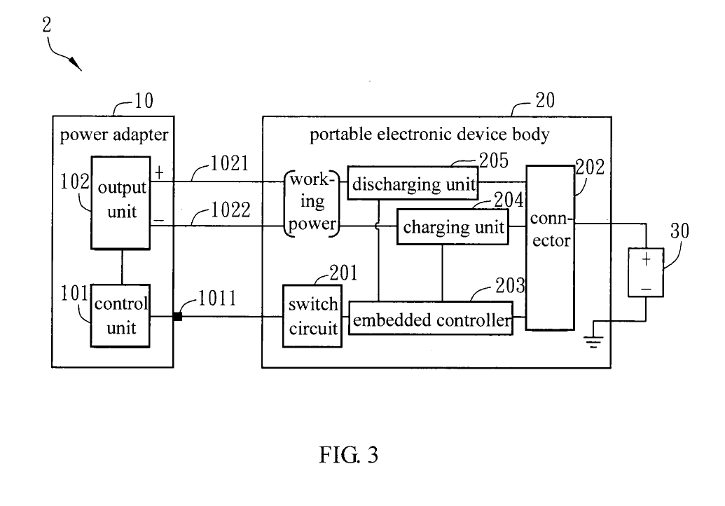

FIG. 3 is a functional block diagram showing a power supply system according to another preferred embodiment of the invention. The difference between a power supply system 2 in FIG. 3 and the power supply system 1 in FIG. 1 is that in this embodiment a portable electronic device body 20 further includes a switch circuit 201 coupled with an embedded controller 203 and a control pin 1011. Other modules and the relation therebetween are the same as that in the power supply system 1. Therefore, they are not described for a concise purpose.

In the embodiment, when a rechargeable battery 30 does not need to be charged, the embedded controller 203 controls the switch circuit 201 to be in a first state. That is, when the embedded controller 203 detects that the rechargeable battery 30 is not connected with the connector 202 or a received state parameter of the rechargeable battery 30 indicates that the rechargeable battery 30 does not need to be charged at that moment, the embedded controller 203 controls the switch circuit 201 to be in the first state.

In the embodiment, the first state can be that the switch circuit is opened. In other embodiments, the first state may be that the switch circuit is closed. However, the invention is not limited thereto.

In the embodiment, when the control pin 1011 of the power adapter 10 detects that the switch circuit 201 is in the first state, the embedded controller 203 and the control pin 1011 are not connected, and the control pin 1011 fails to receive any signal from the embedded controller 203. Therefore, the control unit 101 also cannot receive any signal from the control pin 1011. In this condition, the control unit 101 can control the output unit 102 to output a first voltage and supplies power for the portable electronic device body 20 via an output positive electrode 1021 and an output negative electrode 1022.

In other embodiments, when the first state is that the switch circuit is closed, the embedded controller 203 and the control pin 1011 is connected with each other, and the control pin 1011 can correspondingly transmit a signal from the embedded controller 203 to the control unit 101. The control unit 101 can control the output unit 102 to output the first voltage according to the signal. However, the invention is not limited thereto.

In another aspect, in the embodiment, when the state parameter of the rechargeable battery 30 received by the embedded controller 203 indicates that the rechargeable battery 30 needs to be charged, the embedded controller 203 controls the switch circuit 201 to be in a second state. At that moment, the capacity of the rechargeable battery 30 is usually lower than a predetermined value, such as lower than 95% of full capacity of the rechargeable battery 30. However, the invention is not limited thereto.

The same as the above embodiment, in this embodiment, the determination whether the rechargeable battery 30 needs to be charged does not depend on whether the portable electronic device body 20 is started up. In the embodiment, even if the portable electronic device body 20 is in a shutdown state, once the embedded controller 203 determines that the rechargeable battery 30 needs to be charged, the embedded controller 203 can still control the switch circuit 201 to be in the second state.

In the embodiment, the second state can be that the switch circuit is closed. In other embodiments, the second state may be that the switch circuit is opened. However, the invention is not limited thereto.

In the embodiment, when the control pin 1011 of the power adapter 10 detects that the switch circuit 201 is in the second state, the embedded controller 203 and the control pin 1011 is connected with each other, and the control pin 1011 can receive signals from the embedded controller 203. At that moment, the control pin 1011 transmits the signals from the embedded controller 203 to the control unit 101. Thereby, the control unit 101 controls the output unit 102 to output a second voltage to the portable electronic device body 20 via the output positive electrode 1021 and the output negative electrode 1022. The second voltage can maintain the normal operation of the portable electronic device body 20 and can also be used for charging the rechargeable battery 30.

In the embodiment, when the rechargeable battery 30 needs to be charged and the portable electronic device body 20 is in a shutdown state, the second voltage can be mainly used to charge the rechargeable battery 30. However, the invention is not limited thereto.

In other embodiments, when the second state is that the switch circuit is opened, the embedded controller 203 and the control pin 1011 is not connected with each other, and the control pin 1011 fails to receive any signal from the embedded controller 203. Therefore, the signal fails to be transmitted to the control unit 101. At that moment, the control unit 101 can control the output unit 102 to output the second voltage. However, the invention is not limited thereto.

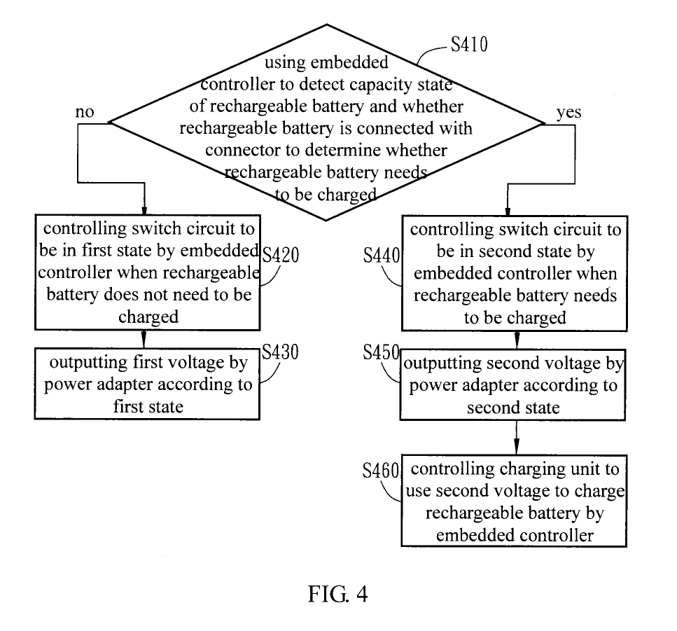

FIG. 4 is a flowchart showing a power supply method according to another preferred embodiment of the invention. Please refer to FIG. 3 and FIG. 4 together.

In step S410, the embedded controller 203 is used to detect a capacity state of the rechargeable battery 30 and whether the rechargeable battery 30 is connected with the connector 202 to determine whether the rechargeable battery needs to be charged. The step is the same as the step 210 in FIG. 2. Therefore, it is not described for a concise purpose.

In step S420, when the rechargeable battery 30 does not needs to be charged, the embedded controller 203 controls the switch circuit 201 to be in the first state.

In the embodiment, when the embedded controller 203 detects that the rechargeable battery 30 is not connected with the connector 202 or the received state parameter of the rechargeable battery 30 indicates that the rechargeable battery 30 does not need to be charged at that moment, the embedded controller 203 controls the switch circuit 201 to be in the first state.

In the embodiment, the first state can be that the switch circuit is opened. In other embodiment, the first state may be that the switch circuit is closed. However, the invention is not limited thereto.

In step S430, the power adapter 10 output a first voltage according to the first state.

In detail, in the embodiment, the embedded controller 203 controls the state of the switch circuit 201 according to the detected capacity state of the rechargeable battery 30 and whether the rechargeable battery 30 is connected with the connector 202. When the switch circuit 201 is in the first state, that is, the switch circuit is opened, the control unit 101 fails to receives any signal from the control pin 1011, thus controlling the output unit 102 to output the first voltage to supply power for the portable electronic device body 20.

In step S440, when the rechargeable battery 30 needs to be charged, the embedded controller 203 controls the switch circuit 201 to be in the second state.

In the embodiment, when the state parameter of the rechargeable battery 30 received by the embedded controller 203 indicates that the rechargeable battery 30 needs to be charged, the embedded controller 203 controls the switch circuit 201 to be in the second state. At that moment, the capacity of the rechargeable battery 30 is usually lower than a predetermined value. However, the invention is not limited thereto.

In the embodiment, the second state can be that the switch circuit is closed. In other embodiments, the second state may be that the switch circuit is opened. However, the invention is not limited thereto.

In step S450, the power adapter 10 outputs a second voltage according to the second state.

In detail, when the switch circuit 201 is in the second state, that is, the switch circuit is closed, the control pin 1011 transmits the signal from the embedded controller 203 to the control unit 101. Thereby, the control unit 101 controls the output unit 102 to output the second voltage to the portable electronic device body 20. The second voltage is greater than the first voltage.

In step S460, the embedded controller 203 controls the charging unit 204 to use the second voltage to charge the rechargeable battery 30.

In the embodiment, in one aspect, the second voltage is used as a working voltage for the portable electronic device body 20 to maintain the normal operation. In another aspect, the charging unit 204 is controlled by the embedded controller 203 to convert the second voltage to a charging voltage of the rechargeable battery 30 to charge the rechargeable battery 30.

During the above method, the power adapter 10 is connected with the portable electronic device body 20. In addition, when the embedded controller 203 detects that the power adapter 10 is not connected with the portable electronic device body 20, the embedded controller 203 controls the discharging unit 205 to discharge the rechargeable battery 30 thus to provide the working voltage for the portable electronic device body 20 to maintain the normal operation thereof.

To sum up, according to the power supply system in the invention, the power adapter additionally has a control pin, and the embedded controller is used to detect the capacity state of the rechargeable battery and whether the rechargeable battery is connected with the connector thus to determine whether the rechargeable battery needs to be charged. According to the different states of the rechargeable battery, different voltages can be outputted and supplied to the computer system. When the rechargeable battery needs to be charged, the second voltage (that is, the higher voltage) is outputted. When the rechargeable battery does not need to be charged (the battery is not connected or is fully charged), the first voltage (that is, the lower voltage) is outputted. Thereby, power conversion efficiency of the portable electronic device can be improved, and the structure is simple and is easy to be realized.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A power supply system with a power saving function for a rechargeable battery, the power supply system comprising:
a power adapter having a control pin; and
a portable electronic device body including:
a connector for connecting the rechargeable battery;
a charging unit coupled with the connector and the power adapter; and
an embedded controller coupled with the control pin, the connector, and the charging unit, the embedded controller used for detecting a capacity state of the rechargeable battery and whether the rechargeable battery is connected with the connector to determine whether the rechargeable battery needs to be charged,
wherein when the rechargeable battery does not need to be charged, the embedded controller controls the power adapter to output a first voltage to the portable electronic device body via the control pin,
when the rechargeable battery needs to be charged, the embedded controller controls the power adapter to output a second voltage to the portable electronic device body via the control pin and controls the charging unit to use the second voltage to charge the rechargeable battery, and the first voltage is lower than the second voltage.

2. The power supply system according to claim 1, wherein when the rechargeable battery does not need to be charged, the embedded controller outputs a first state control signal.

3. The power supply system according to claim 2, wherein when the rechargeable battery needs to be charged, the embedded controller outputs a second state control signal.

4. The power supply system according to claim 3, wherein the first state control signal is a low level control signal, and the second state control signal is a high level control signal.

5. The power supply system according to claim 3, wherein the first state control signal is a high level control signal, and the second state control signal is a low level control signal.

6. The power supply system according to claim 1, wherein the power adapter further comprises a control unit and an output unit, and the control unit is coupled with the output unit and the control pin, respectively.

7. The power supply system according to claim 1, wherein the portable electronic device body further comprises a switch circuit coupled with the embedded controller and the control pin.

8. The power supply system according to claim 7, wherein when the rechargeable battery does not need to be charged, the embedded controller controls the switch circuit to be in a first state, and when the rechargeable battery needs to be charged, the embedded controller controls the switch circuit to be in a second state.

9. The power supply system according to claim 8, wherein the first state is that the switch circuit is opened, and the second state is that the switch circuit is closed.

10. The power supply system according to claim 8, wherein the first state is that the switch circuit is closed, and the second state is that the switch circuit is opened.

11. The power supply system according to claim 1, wherein the portable electronic device body further comprises a discharging unit coupled with the connector and the embedded controller.

12. The power supply system according to claim 1, wherein when the rechargeable battery does not need to be charged, a capacity of the rechargeable battery is greater than a predetermined value or the rechargeable battery is not connected with the connector.

13. The power supply system according to claim 1, wherein the first voltage is 12V.

14. The power supply system according to claim 1, wherein the second voltage is 19V.

15. A power supply method with a power saving function for a rechargeable battery, the power supply method comprising the following steps of:
using an embedded controller to detect a capacity state of the rechargeable battery and whether the rechargeable battery is connected with a connector to determine whether the rechargeable battery needs to be charged; and
controlling a power adapter to output a first voltage via a control pin by the embedded controller when the rechargeable battery does not need to be charged,
controlling the power adapter to output a second voltage via the control pin and controlling a charging unit to use the second voltage to charge the rechargeable battery by the embedded controller when the rechargeable battery needs to be charged, the first voltage being lower than the second voltage.

16. The power supply method according to claim 15, wherein the step of controlling the power adapter to output the first voltage via the control pin by the embedded controller when the rechargeable battery does not need to be charged comprises the following steps of:
outputting a first state control signal by the embedded controller when the rechargeable battery does not need to be charged; and
outputting the first voltage according to the first state control signal by the power adapter.

17. The power supply method according to claim 16, wherein the step of controlling the power adapter to output the second voltage via the control pin and controlling the charging unit to use the second voltage to charge the rechargeable battery by the embedded controller when the rechargeable battery needs to be charged comprises the following steps of:
outputting a second state control signal by the embedded controller when the rechargeable battery needs to be charged;
outputting the second voltage according to the second state control signal by the power adapter; and
controlling the charging unit to use the second voltage to charge the rechargeable battery by the embedded controller.

18. The power supply method according to claim 15, wherein the step of controlling the power adapter to output the first voltage via the control pin by the embedded controller when the rechargeable battery does not need to be charged comprises the following steps of:
controlling a switch circuit to be in a first state by the embedded controller when the rechargeable battery does not need to be charged; and
outputting the first voltage according to the first state by the power adapter.

19. The power supply method according to claim 18, wherein the step of controlling the power adapter to output the second voltage via the control pin and controlling the charging unit to use the second voltage to charge the rechargeable battery by the embedded controller when the rechargeable battery needs to be charged comprises the following steps of:
controlling the switch circuit to be in a second state by the embedded controller when the rechargeable battery needs to be charged;
outputting the second voltage according to the second state by the power adapter; and
controlling the charging unit to use the second voltage to charge the rechargeable battery by the embedded controller.
